(19) United States
(12) Patent Application Publication
(10) Pub. No.: US 2026/0106067 A1
(43) Pub. Date: Apr. 16, 2026

(54) COIL ELECTRONIC COMPONENT

(71) Applicant: SAMSUNG ELECTRO-MECHANICS CO., LTD., Suwon-si (KR)

(72) Inventors: Han Lee, Suwon-si (KR); Boumseock Kim, Suwon-si (KR); Jongwook Lee, Suwon-si (KR)

(73) Assignee: SAMSUNG ELECTRO-MECHANICS CO., LTD., Suwon-si (KR)

(21) Appl. No.: 19/088,812

(22) Filed: Mar. 24, 2025

(30) Foreign Application Priority Data
Oct. 16, 2024 (KR) 10-2024-0140870

(51) Int. Cl. H01F 27/28; H01F 27/24

(52) U.S. Cl. CPC H01F 27/2804; H01F 27/24; H01F 2027/2809

(57) ABSTRACT

Disclosed is a coil electronic component which includes: a support member made of glass material and including a first surface and a second surface; a coil pattern disposed on the support member; and a body including a magnetic material and surrounding the support member and the coil pattern, in which the coil pattern may include a first coil pattern disposed on the first surface of the support member, and a second coil pattern disposed on the second surface of the support member and connected to the first coil pattern.

### CROSS-REFERENCE TO RELATED APPLICATION

This application claims priority to and the benefit of Korean Patent Application No. 10-2024-0140870 filed in the Korean Intellectual Property Office on Oct. 16, 2024, the entire contents of which are incorporated herein by reference.

### TECHNICAL FIELD

The present disclosure relates to a coil electronic component.

### BACKGROUND

As power consumption increases as a function of a mobile device has diversified in recent years, a coil electronic component having small loss and excellent efficiency is adopted around power management integrated circuit (PMIC) to increase a battery life in mobile devices.

There is a growing demand for a thin power inductor in order to slim products and increase the degree of freedom in component arrangement. Among them, the thin-film inductor can be manufactured by forming a coil on a support member with sputtering or plating. The support member can be deformed by heat or pressure during a process of manufacturing the thin-film inductor. When the support member is deformed, the alignment of the coil may be distracted, exposing the coil to the outside or causing a short, which may reduce the reliability of the thin-film inductor.

### SUMMARY

One aspect of an embodiment attempts to provide a coil electronic component having enhanced reliability.

However, the problems to be solved by the embodiments are not limited to the above-mentioned problems, but can be variously extended within the scope of the technical spirit included in the embodiments.

An embodiment of the present disclosure provides a coil electronic component, which includes: a support member made of glass material and including a first surface and a second surface; a coil pattern disposed on the support member; and a body including a magnetic material and surrounding the support member and the coil pattern, in which the coil pattern may include a first coil pattern disposed on the first surface of the support member, and a second coil pattern disposed on the second surface of the support member, and connected to the first coil pattern.

A partition wall may be disposed between adjacent coils of the coil pattern.

The partition wall may be made of glass material.

The support member and the partition wall may include glass of the same material.

The support member and the partition wall may include photosensitive glass.

The coil electronic component may further include an insulating film disposed between the coil pattern and the body.

The support member may include a through-hole, and the through-hole may be filled with a magnetic material.

The support member may include a via, and the first coil pattern and the second coil pattern may be connected to each other the via.

The first coil pattern may include a first lead out portion exposed from one surface of the body, and the second coil pattern may include a second lead out portion exposed from the other surface of the body.

The coil electronic component may further include: a first external electrode disposed outside the body, and connected to the first lead out portion; and a second external electrode disposed outside the body, and connected to the second lead out portion.

The coil electronic component may further include a surface insulating layer disposed on an outer surface of the body.

According to an embodiment, a coil electronic component with enhanced reliability can be provided.

### BRIEF DESCRIPTION OF THE DRAWINGS

FIG. 1 is a perspective view schematically illustrating a coil electronic component according to an embodiment.

FIG. 2 is a schematic cross-sectional view taken along line I-I′ of FIG. 1.

FIG. 3 is a schematic cross-sectional view taken along line II-II′ of FIG. 1.

FIGS. 4 to 11 are drawings sequentially illustrating a method for manufacturing a coil electronic component according to an embodiment.

### DETAILED DESCRIPTION

Hereinafter, embodiments of the present disclosure will be described in detail so as to be easily implemented by those skilled in the art, with reference to the accompanying drawings. The drawings and description are to be regarded as illustrative in nature and not restrictive. Like reference numerals designate like elements throughout the specification. Further, some components in the drawing may be exaggerated, omitted, or schematically illustrated, and a size of each component does not reflect the actual size entirely.

It is to be understood that the accompanying drawings are just used for easily understanding the embodiments disclosed in this specification and a technical spirit disclosed in this specification is not limited by the accompanying drawings and all changes, equivalents, or substitutes included in the spirit and the technical scope of the present disclosure are included.

Terms including an ordinary number, such as first and second, are used for describing various components, but the components are not limited by the terms. The terms are used only to discriminate one component from another component.

Further, it will be understood that when an element such as a layer, film, region, or substrate is referred to as being “on” another element, it can be directly on the other element or intervening elements may also be present. In contrast, when an element is referred to as being “directly on” another element, there are no intervening elements present. In addition, to be referred to as “on” or “on” a reference portion is located above or below the reference portion, and does not particularly mean to “above” or “on” the direction opposite to gravity.

Throughout the specification, it should be understood that the term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance. Accordingly, unless explicitly described to the contrary, the word “comprise”, and variations such as “comprises” or “comprising”, will be understood to imply the inclusion of stated elements but not the exclusion of any other elements.

Further, throughout the specification, “plan view” means that a target part is viewed from the top, and “cross-sectional view” means that a cross section vertically cutting the target part is viewed from the side.

In addition, throughout the specification, the term “connected” does not mean that two or more components are directly connected, but may mean being indirectly connected to the two or more components through other components, and electrically connected, or may be referred to as different names according to a location or function, but may be integrated.

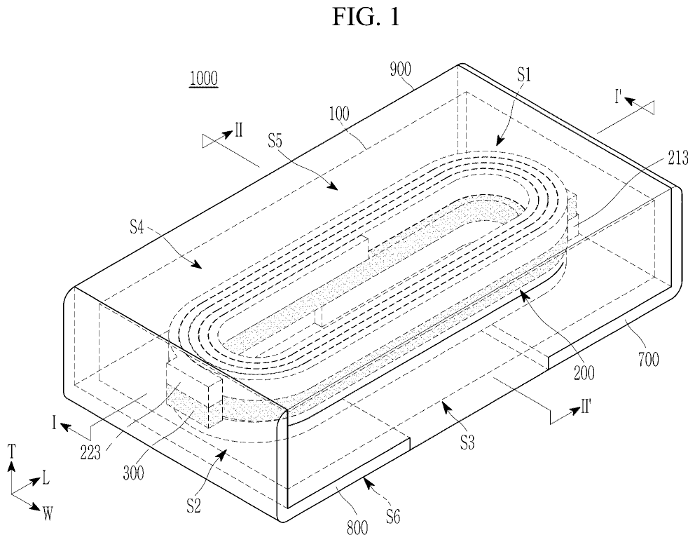

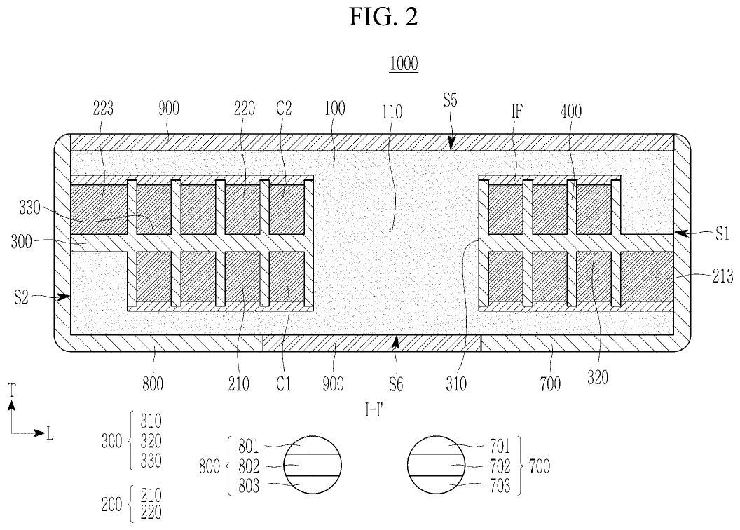

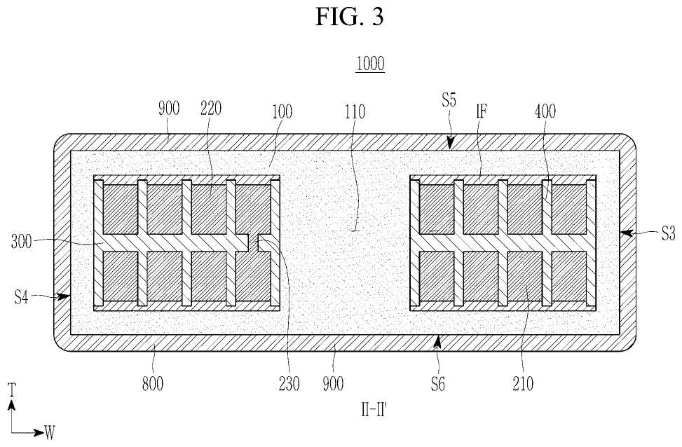

FIG. 1 is a perspective view schematically illustrating a coil electronic component according to an embodiment, FIG. 2 is a schematic cross-sectional view taken along line I-I′ of FIG. 1, and FIG. 3 is a schematic cross-sectional view taken along line II-II′ of FIG. 1.

Referring to FIGS. 1, 2, and 3, the coil electronic component 1000 includes a body 100, a coil 200, a support member 300, a first external electrode 700, a second external electrode 800, and a surface insulation layer 900.

The body 100 may have a substantially rectangular parallelepiped shape, but the embodiment is not limited thereto. Due to shrinkage of magnetic power, etc., during sintering, the body 100 may not have a perfect rectangular parallelepiped shape, but may have a substantially rectangular parallelepiped shape. For example, the body 100 has a substantially rectangular parallelepiped shape, but portions corresponding to a corner or a vertex may have a round shape.

In the present embodiment, for convenience of description, two surfaces of the body opposing each other in a length direction (L-axis direction) will be defined as a first surface S1 and a second surface S2, two surfaces of the body 100 opposing each other in the width direction (W-axis direction) will be defined as a third surface S3 and a fourth surface S4, and two surfaces of the body 100 opposing each other in the thickness direction (T-axis direction) will be defined as a fifth surface S5 and a sixth surface S6.

A length of the coil electronic component 1000 may mean, based on an optical microscope or a scanning electron microscope (SEM) photograph of a cross-section taken along the length direction (L-axis direction)-thickness direction (T-axis direction) at a center of the coil electronic component 1000 in the width direction (W-axis direction), a maximum value among lengths of a plurality of line segments which connect two outermost boundary lines opposing each other in the length direction (L-axis direction) of the coil electronic component 1000 shown the above-described cross-sectional photo, respectively, and are parallel to the length direction (L-axis direction). Alternatively, the length of the coil electronic component 1000 may mean a minimum value among lengths of a plurality of line segments which connect two outermost boundary lines opposing each other in the length direction (L-axis direction) of the coil electronic component 1000 shown in the cross-sectional photograph, respectively, and are parallel to the length direction (L-axis direction). Alternatively, the length of the coil electronic component 1000 may mean an arithmetic mean value of lengths of at least two line segments among the plurality of line segments, which connect two outermost boundary lines opposing each other in the length direction (L-axis direction) of the coil electronic component 1000 shown in the above-described cross-sectional photo, and are parallel to the length direction (L-axis direction), respectively.

A thickness of the coil electronic component 1000 may mean, based on an optical microscope or scanning electron microscope (SEM) photograph of a cross-section taken along the length direction (L-axis direction)-thickness direction (T-axis direction) at a center of the coil electronic component 1000 in the width direction (W-axis direction), a maximum value of lengths of a plurality of line segments which connect two outermost boundary lines opposing each other in the thickness direction (T-axis direction) of the coil electronic component 1000 shown the above-described cross-sectional photo, respectively, and are parallel to the thickness direction (T-axis direction). Alternatively, the thickness of the coil electronic component 1000 may mean a minimum value among lengths of a plurality of line segments which connect two outermost boundary lines opposing each other in the thickness direction (T-axis direction) of the coil electronic component 1000 shown in the cross-sectional photograph, respectively, and are parallel to the thickness direction (T-axis direction). Alternatively, the thickness of the coil electronic component 1000 may mean an arithmetic mean value of lengths of at least two line segments among a plurality of line segments, which connect two outermost boundary lines opposing each other in the thickness direction (T-axis direction) of the coil electronic component 1000 shown in the above-described cross-sectional photograph, and are parallel to the thickness direction (T-axis direction), respectively.

A width of the coil electronic component 1000 may mean, based on an optical microscope or a scanning electron microscope (SEM) photograph of a cross-section taken along the length direction (L-axis direction)-width direction (W-axis direction) at a center of the coil electronic component 1000 in the thickness direction (T-axis direction), a maximum value of lengths of a plurality of line segments which connect two outermost boundary lines opposing each other in the width direction (W-axis direction) of the coil electronic component 1000 shown the above-described cross-sectional photograph, respectively, and are parallel to the width direction (W-axis direction). Alternatively, the width of the coil electronic component 1000 may mean a minimum value among lengths of a plurality of line segments which connect two outermost boundary lines opposing each other in the width direction (W-axis direction) of the coil electronic component 1000 shown in the cross-sectional photograph, respectively, and are parallel to the width direction (W-axis direction). Alternatively, the width of the coil electronic component 1000 may mean an arithmetic mean value of lengths of at least two line segments among a plurality of line segments, which connect two outermost boundary lines opposing each other in the thickness direction (T-axis direction) of the coil electronic component 1000 shown in the above-described cross-sectional photograph, and are parallel to the thickness direction (T-axis direction), respectively.

Each of the length, the width, and the thickness of the coil electronic component 1000 may also be measured using a micrometer measurement method. In the micrometer measurement method, a zero point is set with a micrometer providing repeatability and reproducibility (Gage R&R), the coil electronic component 1000 according to the present embodiment is inserted between tips of the micrometer, and a measuring lever of the micrometer is turned for the measurement. When measuring the length of the coil electronic component 1000 by the micrometer measurement method, the length of the coil electronic component 1000 may mean a value measured once or mean an arithmetic average of values measured a plurality of times. This may be equally applied to measuring the width and the thickness of the coil electronic component 1000.

The body 100 constitutes an exterior of the coil electronic component 1000, and is a space where a magnetic path, which is a path through which the magnetic flux generated by the coil 200 passes, is formed, when a current is applied to the coil 200 through the first external electrode 700 and the second external electrode 800.

The body 100 surrounds and encapsulates the coil 200 and the support member 300, and includes a magnetic material. The body 100 may include magnetic particles, and an insulating material may be interposed between the magnetic particles.

The magnetic material may include a first metal magnetic particle, a second metal magnetic particle having a smaller particle size than the first metal magnetic particle, and a third metal magnetic particle having a smaller particle size than the second metal magnetic particle. An average particle diameter D₅₀ of the first metal magnetic particle may be in a range from about 5 μm to about 30 μm, an average particle diameter D₅₀ of the second metal magnetic particle may be in a range from about 1 μm to about 5 μm, and an average particle diameter D₅₀ of the third metal magnetic particle may be in a range from about 0.05 μm to about 0.5 μm.

The magnetic particle may be ferrite particles or metal magnetic particles exhibiting magnetic properties.

The ferrite particles may include, for example, at least one of spinel-type ferrites such as Mg—Zn-based, Mn—Zn-based, Mn—Mg-based, Cu—Zn-based, Mg—Mn—Sr-based, Ni—Zn-based ferrites, hexagonal ferrites such as Ba—Zn-based, Ba—Mg-based, Ba—Ni-based, Ba—Co-based, Ba—Ni—Co-based ferrites, garnet-type ferrites such as Y-based ferrites and Li-based ferrites.

The metal magnetic particles may be composed of two or more types of powders having different compositions, and may include at least one selected from the group consisting of iron (Fe), silicon (Si), chromium (Cr), cobalt (Co), molybdenum (Mo), aluminum (Al), niobium (Nb), copper (Cu), and nickel (Ni). For example, metal magnetic particles may be at least one of pure iron, Fe—Si-based alloy, Fe—Si—Al-based alloy, Fe—Ni-based alloy, Fe—Ni-Mo-based alloy, Fe—Ni—Mo—Cu-based alloy, Fe—Co-based alloy, Fe—Ni—Co-based alloy, Fe—Cr-based alloy, Fe—Cr—Si-based alloy, Fe—Si—Cu—Nb-based alloy, Fe—Ni—Cr-based alloy, Fe—Cr—Al-based alloy. Here, different compositions of the metal magnetic particles may mean different contents.

The metal magnetic particle may be amorphous or crystalline. For example, the metal magnetic particle may be an Fe—Si—B—Cr-based amorphous alloy, but the embodiment is not limited thereto. The metal magnetic particle may have an average diameter in a range from about 0.1 μm to about 30 μm, but the embodiment is not limited thereto. In the present specification, the average diameter may mean a particle size distribution expressed by D₉₀, D₅₀, or the like. The particle size distribution is well known to those skilled in the art as an index indicating what size (particle size) particles are included in what proportion in a particle group to be measured. D₅₀ (a particle size corresponding to 50 % of a cumulative volume of the particle size distribution) refers to an average particle diameter.

The metal magnetic particles may be two or more types of different metal magnetic particles. Here, by different types of metal magnetic particles, it is meant that the metal magnetic particles are distinguished from each other in at least one of average particle size, composition, component ratio, crystallinity, and shape. The insulating material may include epoxy, polyimide, liquid crystal polymer, etc., alone or in combination, but the embodiment is not limited thereto. The support member 300 is disposed inside the body 100, and supports the coil 200.

When viewed in the thickness direction (T-axis direction), the support member 300 may have the same shape as a shape formed by the edges of the coil 200, or may have a rectangular shape wider than the coil 200. However, the embodiment is not limited thereto.

The support member 300 may include glass.

For example, the glass included in the support member 300 may be SiO₂—B₂O₃-based glass, SiO₂—B₂O₃—K₂O-based glass, SiO₂—B₂O₃—Li₂O—CaO-based glass, SiO₂—B₂O₃—Li₂O—CaO—ZnO-based glass, and Bi₂O₃—B₂O₃—SiO₂—Al₂O₃-based glass. As another example, the support member 300 may be made of photosensitive glass including silica, lithium (Li) oxide, aluminum (Al), and cerium (Ce) oxide.

In an embodiment, the glass included in the support member 300 may also include. The filler included in the glass may include, for example, quartz, alumina, magnesia, silica, forsterite (Mg₂SiO₄), steatite (H₂Mg₃(SiO₃)₄), and zirconia.

The support member 300 may include a first support surface 320 and a second support surface 330 opposite each other in the thickness direction (T-axis direction). A through-hole 310 may be at a center of the support member 300, and the through-hole 310 may be filled with a magnetic material to form a core 110 of the body 100.

The coil 200 is embedded in the body 100 exhibit the characteristics of the coil electronic component 1000. For example, when the coil electronic component 1000 according to the embodiment is used as a power inductor, when current is applied to the coil 200, the coil 200 may serve to stabilize the power of an electronic device by storing an electric field in the form of a magnetic field to maintain an output voltage.

When viewed in the thickness direction (T-axis direction), the coil 200 may be spiral.

The coil 200 may be disposed on the first support surface 320 and the second support surface 330 of the support member 300. The coil 200 may include a first coil pattern 210 and a second coil pattern 220, and the first coil pattern 210 and the second coil pattern 220 may be connected to each other through a via 230. The first coil pattern 210 and the second coil pattern 220 connected in this manner may comprise a spiral coil 200 having one or more turns.

The first coil pattern 210 is disposed on the first support surface 320 of the support member 300.

The first coil pattern 210 includes a first lead out portion 213. The first lead out portion 213 may be exposed from the first surface S1 of the body 100 and may be electrically connected to the first external electrode 700.

The second coil pattern 220 is disposed on the second support surface 330 of the support member 300.

The second coil pattern 220 includes a second lead out portion 223. The second lead out portion 223 may be exposed from the second surface S2 of the body 100 and may be electrically connected to the second external electrode 800. The coil 200 and the via 230 may be formed of a conductive material such as copper (Cu), aluminum (Al), silver (Ag), tin (Sn), gold (Au), nickel (Ni), lead (Pb), titanium (Ti), or an alloy thereof, respectively, but the embodiment is not limited thereto.

A partition wall 400 is disposed between adjacent coils of the first coil pattern 210 and the second coil pattern 220. The partition wall 400 is disposed between the core 110 and the innermost coil C1 of the first coil pattern 210, and the partition wall 400 is disposed between the core 110 and the innermost coil C2 of the second coil pattern 220.

The partition wall 400 may have a shape extending from a surface of the support member 300 in the thickness direction (T-axis direction).

The partition wall 400 may be made of an electrically insulating material. The partition wall 400 may be made of glass.

The partition wall 400 may include the same glass as the support member 300. In this case, glass is stronger than polymer, so it is less likely to cause current leakage or short in the coil.

An insulating film IF may be disposed between the coil 200 and the body 100. The insulating film IF may be formed along the surface of the coil 200. Since the partition wall 400 is disposed between the adjacent coils of the coil patterns 210 and 220, the insulating film IF is not present in that area, and no insulating film IF is present where the coil 200 and the support member 300 are connected to the first external electrode 121 and the second external electrode 122.

The insulating film IF is for insulating the coil 200 from the body 100 may include a known insulating material such as parylene, etc. Any insulating material may be used in the insulating film IF, and there is no particular limitation. For example, the insulating film IF may be a polyurethane resin, a polyester resin, an epoxy resin, or a polyamideimide resin. The insulating film IF may be formed by a method such as vapor deposition, etc., but is not limited thereto. For example, the insulating film IF may be formed by stacking insulating films on both surfaces of the support member 300.

The first external electrode 700 and the second external electrode 800 are disposed outside the body 100, and connected to the coil 200.

The first external electrode 700 may be disposed on the first surface S1 of the body 100, and connected to the first lead out portion 213 of the coil 200. The first external electrode 700 covers a portion of the sixth surface S6 of the body 100.

In another embodiment, the first external electrode 700 may cover the first surface S1 of the body 100, and may also cover at least one of a portion of the third surface S3, a portion of the fourth surface S4, a portion of the fifth surface S5, and a portion of the sixth surface S6.

The second external electrode 800 may be disposed on the second surface S2 of the body 100, and connected to the second lead out portion 223 of the coil 200. The second external electrode 800 covers a portion of the sixth surface S6 of the body 100.

In another embodiment, the second external electrode 800 may cover the second surface S2 of the body 100, and may also cover at least a portion of a portion of the third surface S3, a portion of the fourth surface S4, a portion of the fifth surface S5, and a portion of the sixth surface S6.

The first external electrode 700 may include a first metal layer 701, a second metal layer 702, and a third metal layer 703.

The first metal layer 701 may be a plating layer in contact with the first lead out portion 213 and outer surfaces, i.e., the first surface S1 and the sixth surface S6 of the body, and include copper (Cu). The second metal layer 702 may be a plating layer covering the first metal layer 701, and include nickel (Ni). The third metal layer 703 may be a plating layer covering the second metal layer 702, and include tin (Sn). However, the embodiment is not limited to a three-layer structure, and a two-layer structure with only one metal layer added onto the first metal layer 701 is also possible.

The second external electrode 800 may include a first metal layer 801, a second metal layer 802, and a third metal layer 803.

The first metal layer 801 may be a plating layer in contact with the second lead out portion 223 and outer surfaces, i.e., the second surface S2 and the sixth surface S6 of the body, and include copper (Cu). The second metal layer 802 may be a plating layer covering the first metal layer 801, and include nickel (Ni). The third metal layer 803 may be a plating layer covering the second metal layer 802, and include tin (Sn). However, the embodiment is not limited to a three-layer structure, and a two-layer structure with only one metal layer added onto the first metal layer 801 is also possible.

As another example, the first external electrode 700 and the second external electrode 800 may include a metal and glass. The metal may be, for example, a conductive metal including copper (Cu), nickel (Ni), tin (Sn), palladium (Pd), platinum (Pt), gold (Au), silver (Ag), tungsten (W), titanium (Ti), lead (Pb) alone, or alloys thereof. The glass component included in the first external electrode 700 and the second external electrode 800 may be a mixture of oxides. The glass component may include, for example, a silicon oxide, a boron oxide, an aluminum oxide, a transition metal oxide, an alkaline metal oxide, an alkaline-earth metal oxide, or combinations thereof. Here, the transition metal may be selected from zinc (Zn), titanium (Ti), copper (Cu), vanadium (V), manganese (Mn), iron (Fe), or nickel (Ni), the alkaline metal may be selected from lithium (Li), sodium (Na), or potassium (K), and the alkaline-earth metal may be selected from magnesium (Mg), calcium (Ca), strontium (Sr), or barium (Ba). The method for forming the first external electrode 700 and the second external electrode 800 is not particularly limited. For example, the first external electrode 700 and the second external electrode 800 may be formed by dipping the body 100 into a conductive paste containing metal and glass, or by printing a conductive paste on a surface of the body 100 by, e.g., screen printing method or gravure printing method. Further, various methods, such as applying a conductive paste on the surface of the body 100, or transferring a dry film formed by drying the conductive paste on the body 100, may be used to form the first external electrode 700 and the second external electrode 800.

The surface insulating layer 900 may be disposed on the third surface S3, the fourth surface S4, the fifth surface S5, and the sixth surface S6 of the body 100. However, the surface insulating layer 900 may partially cover the sixth surface S6 of the body 100. That is, the first external electrode 700 and the second external electrode 800 may be disposed on the sixth surface S6 of the body 100, and the surface insulating layer 900 may not cover the first external electrode 700 and the second external electrode 800.

As described above, the surface insulating layer 900 is disposed on at least a portion of the third surface S3, the fourth surface S4, the fifth surface S5, and the sixth surface S6 of the body 100 to prevent electrical shorts between other electronic components and the first and second external electrode 700 and 800.

The surface insulating layer 900 may be used as a resist when forming the first external electrode 700 and the second external electrode 800 by electroplating, but is not limited thereto.

The surface insulating layer 900 may include polymer resin, pigment, filler, etc. The polymer resin may include a thermosetting polymer resin such as epoxy or a thermoplastic polymer resin such as acryl. Pigments capable of producing color such as black, may include carbon black, black manganese (Mn)-based spinel powder, etc. and the surface insulation layer may further include additives such as SiO₂ and talc, for control of strength and/or coefficient of thermal expansion For example, the surface insulating layer 900 may include a thermoplastic resin such as a polystyrene-based resin, a vinyl acetate-based resin, a polyester-based resin, a polyethylene-based resin, a polypropylene-based resin, a polyamide-based resin, a rubber-based resin, an acryl-based resin, or the like, a thermosetting resin such as a phenol-based resin, an epoxy-based resin, a urethane-based resin, a melamine-based resin, an alkyd-based resin, a photosensitive resin, parylene, SiOₓ or SiNₓ.

The surface insulating layer 900 may be formed through a process such as screen printing, pad printing, dipping, spray printing, etc. For example, the surface insulating layer 900 may be formed, by applying a liquid insulating resin to a surface of the body 100, or by stacking an insulating film such as a dry film on the surface of the body 100, or through a thin-film process such as vapor deposition, etc. In the case of the insulating films, Ajinomoto Build-up Film (ABF) or polyimide film, or the like, may be used.

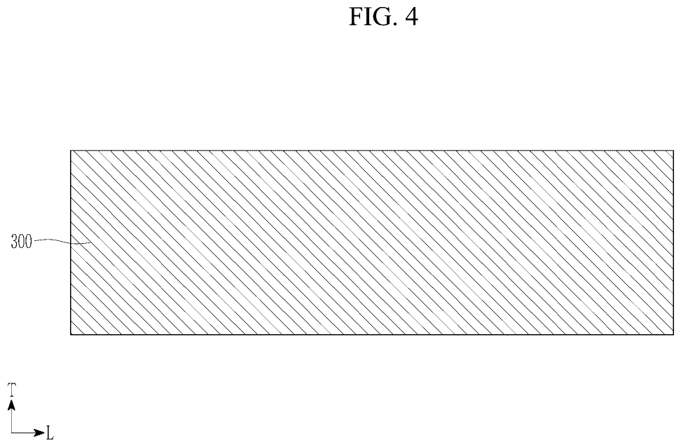

FIGS. 4 to 11 are drawings sequentially illustrating a method for manufacturing a coil electronic component according to an embodiment.

Referring to FIG. 4, a support member 300 made of glass material is provided.

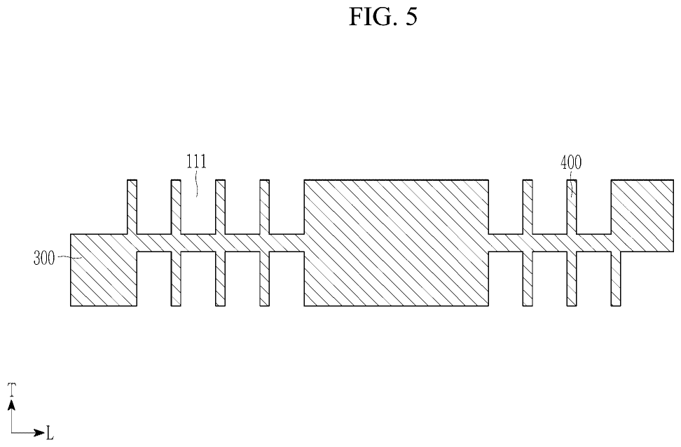

Referring to FIG. 5, a trench 111 is formed by etching the support member 300. For example, the trench 111 may be formed by irradiating a laser beam onto the support member 300 or performing a wet etch process on the support member 300.

The trench 111 may be formed to have various patterns. For example, the trench 111 may be formed to be spiral.

A partition wall 400 may be formed between the trenches 111.

Since the support member 300 is made of glass, the trench 111 may be formed to have a relatively high aspect ratio. That is, when a laser beam is irradiated onto the support member 300 made of glass, the straightness of the laser beam is excellent, thereby increasing the aspect ratio of the trench 111. For example, the aspect ratio of the trench 111 may be 3:1 or more or 20:1 or less. As a result, since the trenches 111 may be disposed at a relatively high density, and disposed to be closer to each other with a fine pitch.

Unlike the embodiment, when an insulating film is disposed on the support member, and then a trench is formed by irradiating a laser beam onto the insulating film, it is difficult to increase the aspect ratio of the trench due to scattering of the laser beam. In this case, the pitch of the trench may not be as fine as in the present embodiment.

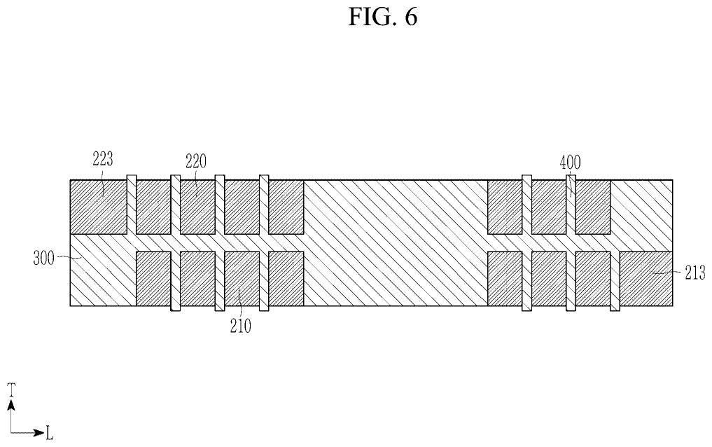

Referring to FIG. 6, a coil 200 is formed by filling the trench 111 with metal. The metal filled in the trench 111 forms the coil 200. For example, the coil 200 may be formed by plating the trench 111 with copper (Cu). As a result, a first coil pattern 210, a second coil pattern 220, a first lead out portion 213, a second lead out portion 223, etc., may be formed.

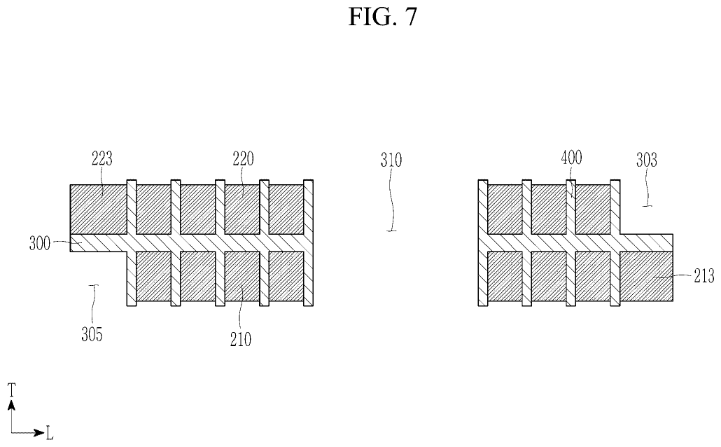

Referring to FIG. 7, a through-hole 310 is formed by etching a central portion of the support member 300. For example, the through-hole 310 may be formed by irradiating a laser beam onto the center of the support member 300 or performing the wet etch process on the support member 300. Furthermore, an area 303 facing the first lead out portion 213 and an area 305 facing the second lead out portion 223 may be etched on the support member 300.

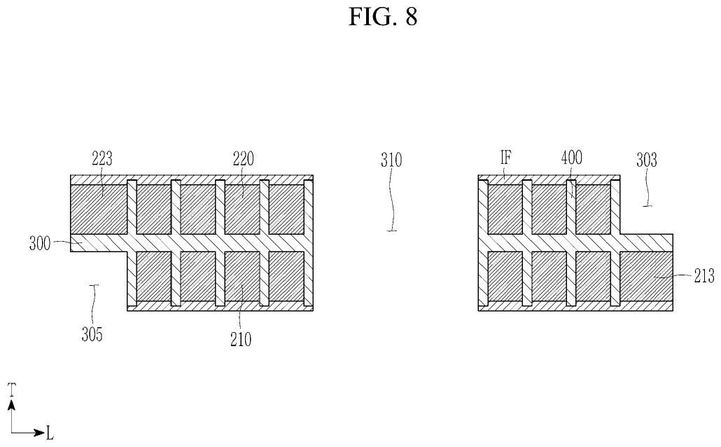

Referring to FIG. 8, an insulating film IF is formed on the coil 200. As a result, the surface of the coil 200 except for portions of the first lead out portion 213 and the second lead out portion 223 may be covered with the insulating film IF and the partition wall 400. The insulating film IF may not be formed in the areas 303 and 305.

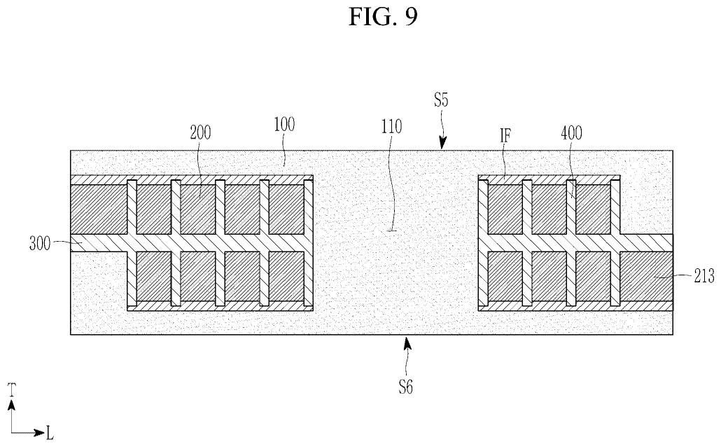

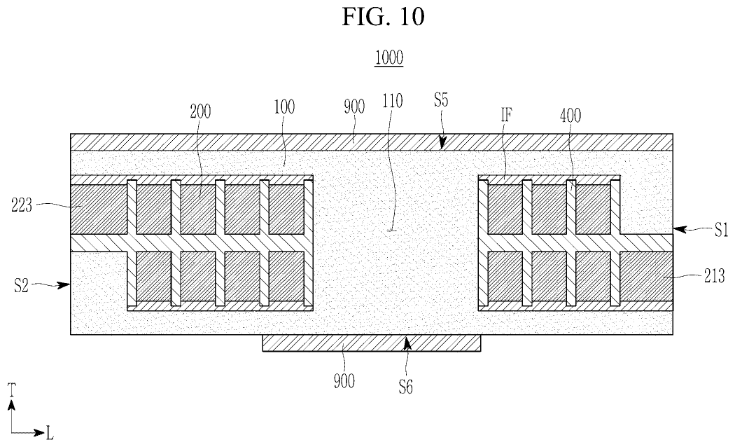

Referring to FIG. 9, a body 100 is formed to surround the coil 200 and the support member 300. During this process, the through-hole 310 of the support member 300 is filled with a magnetic material to form a core 110. Furthermore, the areas 303 and 305 (see FIG. 8) may be filled with the magnetic material. For example, sheets of magnetic material may be disposed at an upper portion and a lower portion of the coil 200, and then pressed and cured to form the body 100. Referring to FIG. 10, a surface insulating layer 900 is formed on an outer surface of the body 100 except for portion where a first external electrode 700 and a second external electrode 800 are to be formed.

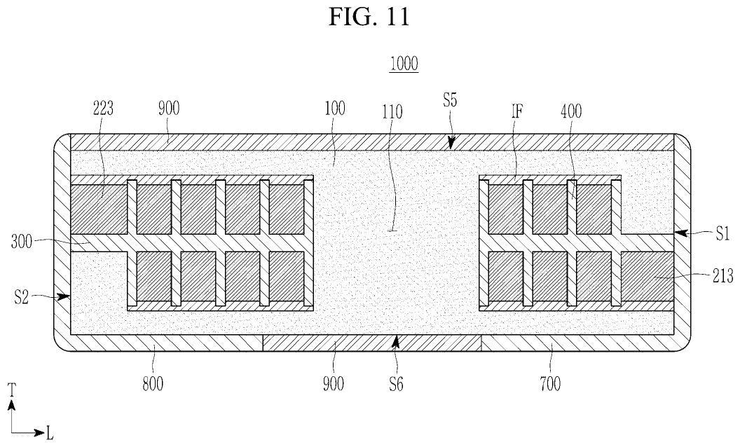

Referring to FIG. 11, a coil electronic component 1000 is manufactured by forming the first external electrode 700 and the second external electrode 800 are formed on an outer surface of the body 100. For example, a conductive paste is applied to a first surface S1 and a sixth surface S6 of the body 100 and then cured to form the first external electrode 700, and a conductive paste is applied to a second surface S2 and a sixth surface S6 of the body 100 and then cured to form the second external electrode 800. As another example, the first surface S1 and the sixth surface S6 of the body 100 are plated with metal to form the first external electrode 700, and the second surface S2 and the sixth surface S6 of the body are plated with the metal to form the second external electrode 800. Thus, the first external electrode 700 is connected to the first lead out portion 213, and the second external electrode 800 is connected to the second lead out portion 223. Although the embodiment of the present disclosure is described hereinabove, the present disclosure is not limited thereto, and various modifications can be made within the scopes of the claims, and the description of the present disclosure and the accompanying drawings, and belongs to the scope of the present disclosure, of course.

### DESCRIPTION OF SYMBOLS

1000: Coil electron component
100: Body
200: Coil
210: First coil pattern
220: Second coil pattern
230: Via
213: First lead out portion
223: Second lead out portion
300: Supporting member
700: First external electrode
800: Second external electrode
900: Surface insulating layer

What is claimed is:

1. A coil electronic component comprising:
a support member made of glass material and including a first surface and a second surface;
a coil pattern disposed on the support member; and
a body including a magnetic material and surrounding the support member and the coil pattern,
wherein the coil pattern includes
a first coil pattern disposed on the first surface of the support member, and
a second coil pattern disposed on the second surface of the support member and connected to the first coil pattern.

2. The coil electronic component of claim 1, wherein
a partition wall is disposed between adjacent coils of the coil pattern.

3. The coil electronic component of claim 2, wherein
the partition wall is made of the glass material.

4. The coil electronic component of claim 3, wherein
the support member and the partition wall include glass of the same material.

5. The coil electronic component of claim 3, wherein
the support member and the partition wall include photosensitive glass.

6. The coil electronic component of claim 2, further comprising:
an insulating film disposed between the coil pattern and the body.

7. The coil electronic component of claim 1, wherein
the support member includes a through-hole, and
the through-hole is filled with the magnetic material.

8. The coil electronic component of claim 1, wherein
the support member includes a via, and
the first coil pattern and the second coil pattern are connected to each other through the via.

9. The coil electronic component of claim 1, wherein
the first coil pattern includes a first lead out portion exposed from one surface of the body, and
the second coil pattern includes a second lead out portion exposed from an other surface of the body.

10. The coil electronic component of claim 9, further comprising:
a first external electrode disposed outside the body and connected to the first lead out portion; and
a second external electrode disposed outside the body and connected to the second lead out portion.

11. The coil electronic component of claim 1, further comprising:
a surface insulating layer disposed on an outer surface of the body.

12. A coil electronic component, comprising:
a support member having a through-hole, comprising a glass material;
a core filling the through-hole, comprising a magnetic material;
a coil pattern disposed on a surface of the support member and comprising a plurality of turns around the core; and
a body including the magnetic material and surrounding the support member and the coil pattern.

13. The coil electronic component of claim 12, further comprising an insulating film disposed between the coil pattern and the body.

14. The coil electronic component of claim 12, further comprising a partition wall separating adjacent turns of the coil pattern, the partition wall comprising the glass material.

15. The coil electronic component of claim 14, wherein the glass material comprising the support member and the partition wall includes photosensitive glass.
